(19) United States
(12) Patent Application Publication
(10) Pub. No.: US 2024/0107989 A1
(43) Pub. Date: Apr. 4, 2024

(54) PROPELLER JIG

(71) Applicants: Aaron Wiebe, Lac Du Bonnet (CA); Alex Peric, Krum, TX (US)

(72) Inventors: Aaron Wiebe, Lac Du Bonnet (CA); Alex Peric, Krum, TX (US)

(21) Appl. No.: 18/475,837

(22) Filed: Sep. 27, 2023

Related U.S. Application Data
(60) Provisional application No. 63/377,258, filed on Sep. 27, 2022.

(51) Int. Cl. A01K 85/12; A01K 91/04; A01K 99/00

(52) U.S. Cl. CPC A01K 85/128; A01K 91/04; A01K 99/00

(57) ABSTRACT

An exemplary jig fishing lure may include a hook, a head, and a propeller assembly. The hook may be connected to the head at a rear end of the head. The propeller assembly may be rotatably connected to a front end of the head. An exemplary method of making a jig fishing lure may include painting a head and a hook of the jig fishing lure such that an eye is unpainted and a collar is unpainted. After painting, a propeller assembly may be connected to the head by inserting a pin through a propeller and a washer into a front end of the head.

### CROSS-REFERENCE TO RELATED APPLICATION(S)

This application claims priority to U.S. Provisional Patent Application No. 63/377,258 filed on Sep. 27, 2022, the entire contents of which are incorporated herein by reference.

### TECHNICAL FIELD

This disclosure relates to fishing jigs. Exemplary fishing jigs are of a type commonly called a propeller jig.

### INTRODUCTION

The disclosure pertains generally to fishing lures. More specifically, jigs. Jigs are a common fishing lure style that have been used for angling for many years. The addition of propellers or blades provides additional attraction for fish. Propellers are an effective attractant, providing a visible attraction as well as vibrations that are sensed by the fish's lateral line and otoliths. Current applications of jigs with a propeller utilize bulky hardware, often using the hook shank as the propeller spindle and do not account for balancing the jig to engage the propeller while fishing vertically.

### SUMMARY

Considered broadly, jigs have a hook with a weighted head often made from lead or tungsten, disposed on the shank of the hook, adjacent to the eye. Current applications of jigs with a propeller utilize the hook shank as the propeller spindle.

Exemplary jigs disclosed herein include a propeller on the frontmost portion of the jig, in front of the eye of the hook. This maximizes water contact with the propeller blades and allows for a better designed collar. The front mounted propeller also opens up the hook gap and prevents baits (whether real or artificial) from interfering with the propeller's performance. A result is a more natural profile of lure. In various instances, an exemplary jig utilizes a cone shaped or concave washer to reduce friction points with the nose of the jig, while maximizing the mobility of the propeller or multiple propellers. In various instances, exemplary jigs may comprise 1-8 blades.

In one aspect, a jig fishing lure is disclosed. An exemplary jig fishing lure may include a hook, a head having a front end and a rear end, where the hook is connected to the head at the rear end of the head, and a propeller assembly rotatably connected to the front end of the head.

In another aspect, a method of making a jig fishing lure is disclosed. An exemplary jig fishing lure may include a hook, a head having a front end and a rear end, a propeller assembly rotatably connected to the front end of the head, a collar extending from a rear end of the head, the head comprising an eye disposed adjacent the rear end of the head, and the hook being connected to the head at the rear end of the head. An exemplary method of making the jig fishing lure may include masking the eye, masking the collar, painting the head and the hook of the jig fishing lure such that the eye is unpainted and the collar is unpainted, and after painting, connecting the propeller assembly to the head by inserting a pin through a propeller and a washer into a front end of the head.

In another aspect, a jig fishing lure is disclosed. An exemplary jig fishing lure may include a hook; and a head having a front end and a rear end, comprising: an eye disposed adjacent the rear end of the head, where a center of mass of the jig fishing lure is at the eye; the hook being connected to the head at the rear end of the head via a collar, the collar extending from the rear end of the head; and a propeller assembly rotatably connected to the front end of the head, the propeller assembly comprising: between 1 blade and 8 blades, each blade being electroplated; the head comprising a paint layer; the eye being unpainted; and the collar being unpainted.

### BRIEF DESCRIPTION OF THE DRAWINGS

FIG. 1 is a cross section view of an exemplary jig, showing the hook path and pin path through the jig head.

FIG. 2 is a side profile view of an exemplary jig, showing the front portion, rear portion and total length of the jig.

FIG. 3 is a front view of an exemplary jig.

FIG. 4 is a top view of an exemplary jig.

FIG. 5 shows exemplary propeller styles usable with an exemplary jig.

### DETAILED DESCRIPTION

The disclosure provides a fishing lure of the propeller jig type. Generally, the jig includes a jig head comprised of lead, tungsten or tungsten alloy, a collar behind the jig head, a spindle with a washer around which the propeller spins, and a fish hook with a hook shank partially embedded in the jig head. The hook extends from the rear of the jig. The front portion of the hook is embedded in the jig head with the eye of the hook extending out of the top of the jig head, perpendicular to the plane of the hook shank. The unpainted eye of the hook acts as the fastening point for the fishing line and the central point of mass for the jig. The hook eye separates the frontward portion of the jig from the rearward portion of the jig. The frontward portion contains a spindle, and a propeller that rotates around said spindle, and a concave washer. The spindle holds the propeller and washer and extends into the front portion of the jig head along the same axis as the hook shank. The rearward portion of the jig includes the hook shank extending through the unpainted collar, the hook bend and the hook point.

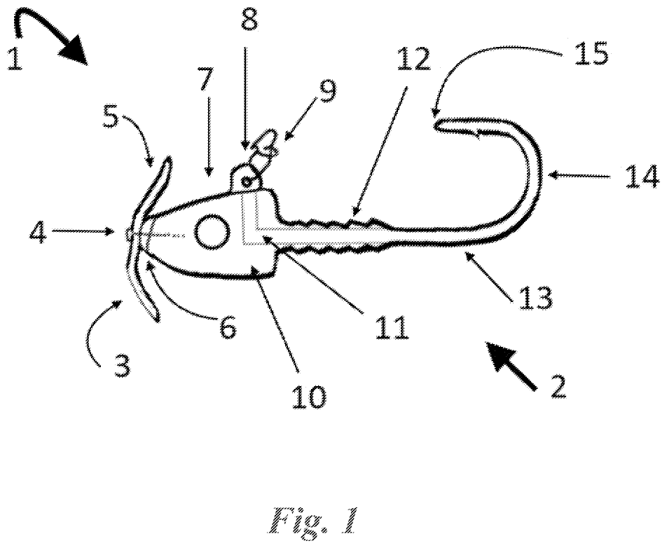

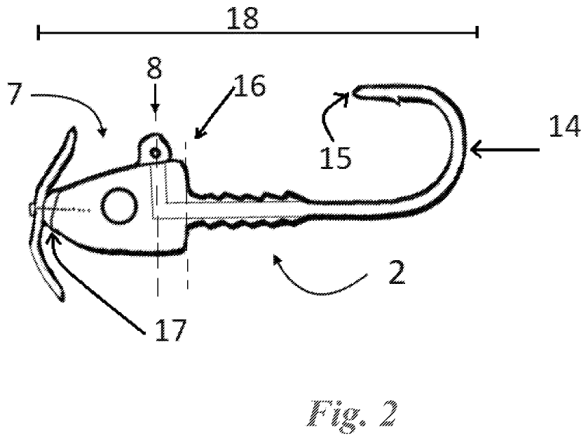

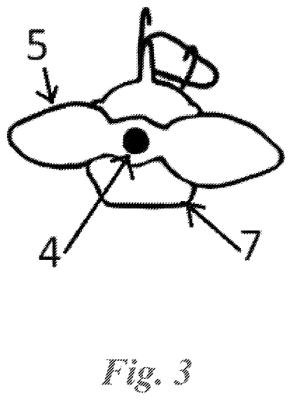

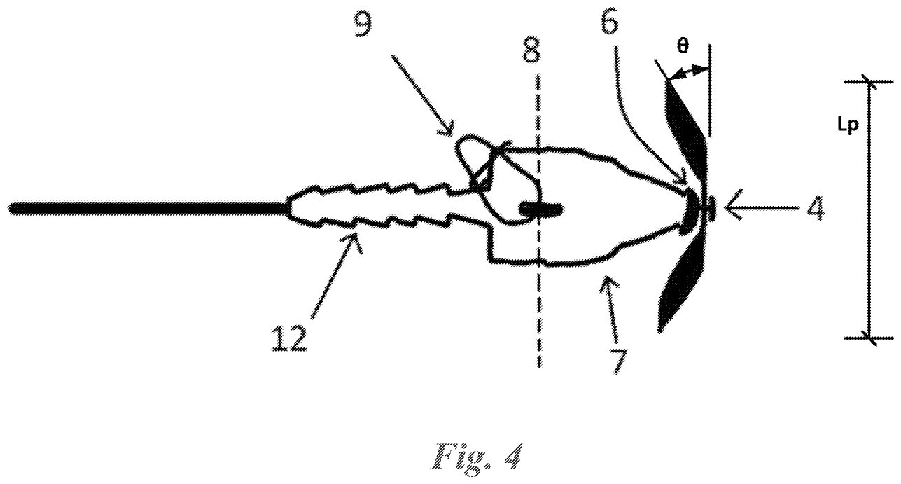

FIG. 1 shows a side cross sectional view of exemplary jig 1. Jig 1 is a jig fishing lure. FIG. 2 is a side profile view of jig 1, showing the front portion, rear portion and total length of the jig 1. FIG. 3 is a front view of jig 1. FIG. 4 is a top view of jig 1. FIGS. 1-4 are discussed concurrently below unless otherwise indicated.

Jig 1 comprises a propeller assembly 3 comprising a pin 4 that acts as a spindle for the propeller 5, a propeller 5 that may rotate about a central axis of spindle 4, and a concave washer 6. The propeller assembly 3 is fastened into the front end 7 of the jig head. In some instances, the propeller assembly 3 may comprise multiple propellers 5, each propeller being supported by, and rotatably mounted about, a central axis of spindle 4.

The propeller 5 blades may be electroplated. Electroplating the blades of propeller 5 may reduce friction while rotating around the pin, and to increase visual attraction for angling. The propeller 5 may have between 1-8 blades.

The propeller 5 blades may be angled so that they rotate when water pressure is applied to them. That is, a portion of propeller 5 blades may be bent. Various angles θ (see FIG. 4) may be used. For example, the blades may have an angle θ between 1 degree and 35 degrees; between 1 degree and 15 degrees; between 15 degrees and 35 degrees. In various instances, the blades may have an angle θ no less than 1 degree; no less than 4 degrees; no less than 5 degrees; no less than 10 degrees; no less than 15 degrees; no less than 20 degrees; no less than 30 degrees; or no less than 35 degrees. In various instances, the blades may have an angle θ no greater than 35 degrees; no greater than 31 degrees; no greater than 26 degrees; no greater than 21 degrees; no greater than 16 degrees; no greater than 11 degrees; no greater than 6 degrees; or no greater than 1 degree.

The length 18 of the propeller may correlate to a propeller length Lp. For example, the propeller length Lp may be between 30% to 40% of the total jig length 18. In various instances, the propeller length Lp may be no less than 30%; no less than 35%; or no less than 40% of the total jig length 18. In various instances, the propeller length Lp may be no greater than 30%; no greater than 35%; or no greater than 40% of the total jig length 18.

A hook 14 is embedded in the lead jig head 10 and the hook path through the lead is shown as 11. The jig collar 12 comprises unpainted lead ridges. In some instances, the jig collar 12 may define between 4 ridges and 6 ridges; between 4 ridges and 5 ridges; between 5 ridges and 6 ridges; or 5 ridges. In various instances, the hook comprises barbs or rings 2 mm-5 mm wide.

The hook shank 13 extends out of collar 12 and then forms the hook bend 14 and hook point 15.

As shown in FIG. 2, the eye of the hook 8 separates the jig 1 into a front portion 7 and a rear portion 2. A center of mass of the jig 1 is located at or near the eye of the hook 8. As shown in FIG. 4, the eye of the hook 8 may be horizontally centered in relation to the center of mass of jig 1. Typically, the eye of the hook 8 is unpainted.

This balance point allows the front portion 7 of the jig 1 to point up when the jig is pulled up in water, and the front portion 7 of the jig 1 to point down when the jig 1 falls in water. This balance causes the propeller 5 to engage while the jig moves both upwards and downwards. A snap or ring 9 may be connected to the eye of the hook 8 to ensure the horizontal balance is achieved.

FIG. 2 shows the head of the jig is a conical shape with the thinnest part being at the frontmost portion of the jig 17. The head gradually widens towards the rearward extent of the head of the jig 16. In some instances, the head of the jig is a truncated conical shape.

In some instances, the rearward extent of the head of the jig 16 is sized between 15%-20% of the total jig length 18.

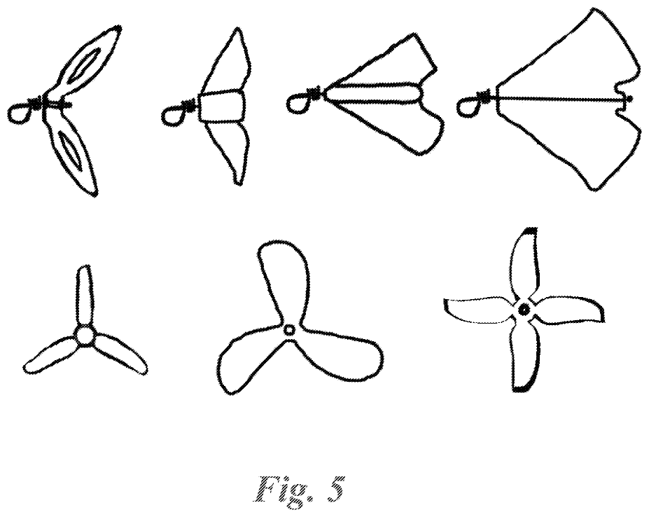

FIG. 5 shows various propeller styles that could be used in various embodiments of the jig 1.

During exemplary manufacturing processes, certain elements are not painted to enhance performance. In an exemplary embodiment, the eye of the hook and the collar is masked. Then the jig is painted. The spindle is a pin with one end flattened to resemble the head of a nail. This pin is inserted through the propeller and washer and then into the frontward portion of the jig. Affixing the propeller assembly to the jig after painting allows smooth rotation of the propeller. This process prevents excess paint or overspray from affecting the performance of the propeller. The process also prevents the paint from cracking or breaking, as would be the case if masking was used as a technique to keep the propeller and spindle clean.

The collar acts to hold artificial or real bait in place that is added to the hook shank of the jig head. Alternatively, a wire can be tied or welded to the hook shank 5 mm-20 mm back from the jig head. The wire may form an acute angle, protruding from the hook shank 1 mm-5 mm. This wire forms a barb that holds the plastic or live bait on.

The body of the jig is made from a dense material. For instance, the body of the jig may be lead, tungsten, tungsten alloy or injection molded plastic. The weight is disposed onto the hook shank so that the weight is balanced anterior and posterior the eye of the jig, resulting in the hook shank balancing horizontally. This embodiment applies a snap or ring through the eye of the hook so the fishing line knot does not affect the balance.

While certain embodiments of the disclosure are explained in detail above, it is to be understood that the disclosure is not limited in its application to the details of construction and the arrangement of components set forth in the following description or illustrated in the drawings. The disclosed technology is capable of other embodiments and of being practiced or of being carried out in various ways.

1. A jig fishing lure, comprising:
a hook;
a head having a front end and a rear end,
the hook being connected to the head at the rear end of the head; and
a propeller assembly rotatably connected to the front end of the head.

2. The jig fishing lure according to claim 1, further comprising a collar extending from the rear end of the head, where a portion of the hook is supported by the collar.

3. The jig fishing lure according to claim 2, the head portion further comprising an eye disposed adjacent the rear end of the head,
where a center of mass of the jig fishing lure is at the eye.

4. The jig fishing lure according to claim 3, the propeller assembly comprising a spindle, a propeller, and a washer;
the propeller configured to rotate about a central axis of the spindle; and
the washer disposed between the propeller and the front end of the head.

5. The jig fishing lure according to claim 4, the propeller comprising between 1 blade and 8 blades.

6. The jig fishing lure according to claim 5, the propeller comprising 2 blades or 3 blades.

7. The jig fishing lure according to claim 4, wherein a length of the propeller is between 30% and 40% of a length of the jig fishing lure.

8. The jig fishing lure according to claim 4, wherein a blade of the propeller is bent at an angle between 1 degree and 35 degrees.

9. The jig fishing lure according to claim 4, the propeller being electroplated.

10. The jig fishing lure according to claim 3, wherein a length of the head is between 15% and 20% of a length of the jig fishing lure.

11. The jig fishing lure according to claim 3, further comprising a ring or a snap supported by the eye, the ring or the snap functioning as a line tie.

12. The jig fishing lure according to claim 3, the head comprising a paint layer;
the eye being unpainted; and
the collar being unpainted.

13. The jig fishing lure according to claim 3, the collar defining between 4 ridges and 6 ridges.

14. The jig fishing lure according to claim 3, the head comprising tungsten or a tungsten alloy.

15. The jig fishing lure according to claim 13, the collar comprising tungsten or a tungsten alloy.

16. The jig fishing lure according to claim 3, the eye being horizontally centered in relation to the center of mass of the jig fishing lure.

17. The jig fishing lure according to claim 1, the head having a truncated conical geometry.

18. A method of making a jig fishing lure comprising a hook, a head having a front end and a rear end, a propeller assembly rotatably connected to the front end of the head, a collar extending from a rear end of the head, the head comprising an eye disposed adjacent the rear end of the head, and the hook being connected to the head at the rear end of the head, the method comprising:
masking the eye;
masking the collar;
painting the head and the hook of the jig fishing lure such that the eye is unpainted and the collar is unpainted; and
after painting, connecting the propeller assembly to the head by inserting a pin through a propeller and a washer into a front end of the head.

19. The method according to claim 18, further comprising:
before mounting the propeller assembly, electroplating blades of the propeller; and
connecting a ring or a snap to the eye.

20. A jig fishing lure, comprising:
a hook; and
a head having a front end and a rear end, comprising:
an eye disposed adjacent the rear end of the head, where a center of mass of the jig fishing lure is at the eye;
the hook being connected to the head at the rear end of the head via a collar, the collar extending from the rear end of the head; and
a propeller assembly rotatably connected to the front end of the head, the propeller assembly comprising:
between 1 blade and 8 blades, each blade being electroplated;
the head comprising a paint layer;
the eye being unpainted; and
the collar being unpainted.
